(19) United States
(12) Patent Application Publication
(10) Pub. No.: US 2026/0093234 A1
(43) Pub. Date: Apr. 2, 2026

(54) DETERMINATION PROGRAM

(71) Applicant: Panasonic Intellectual Property Management Co., Ltd., Osaka (JP)

(72) Inventors: IZURU NAKAI, Osaka (JP); KAZUKI FUJIWARA, Osaka (JP); KOJI FUNAMI, Kyoto (JP); TATSURO SHIRAISHI, Osaka (JP)

(21) Appl. No.: 19/411,759

(22) Filed: Dec. 8, 2025

Related U.S. Application Data
(63) Continuation of application No. PCT/JP2024/014228, filed on Apr. 8, 2024.

(30) Foreign Application Priority Data
Jun. 15, 2023 (JP) 2023-098680

(51) Int. Cl. G05B 19/18

(52) U.S. Cl. CPC G05B 19/188; G05B 2219/45154

(57) ABSTRACT

A determination program is executed by a processing circuit of a monitoring unit that determines a processed state when processing is performed by irradiating a workpiece with laser light. The determination program includes a control program that is not changeable by a user, and a determination algorithm that is selectively implementable with the control program.

### TECHNICAL FIELD

The present disclosure relates to a determination program for a welding process monitor used for processing point monitoring in laser processing.

### BACKGROUND ART

In order to test a manufactured product, a testing device is used that performs a test conforming to the product. Such a test device is controlled according to a predetermined test program. For example, in a semiconductor testing apparatus for testing a semiconductor device, a test program includes a combination of a control program and a test algorithm module that defines a test algorithm. In PTL 1 exemplified as an example, a plurality of test algorithm modules each defining a different test algorithm is stored in an external server, and the test device acquires a target test algorithm module from the external server.

FIG. 12 is a diagram illustrating a structure of a test program installed in a conventional information processing apparatus described in PTL 1.

Test program 1240 includes control program 1302 and program module 1304. Control program 1302 is a basic part of test program 1240, and is commonly used without depending on the type of the device to be tested and the test content. Functions of a hardware access unit, an authentication unit, an execution unit, an interrupt/match detection unit, a display unit, and a reception unit are provided by control program 1302.

Meanwhile, program module 1304 can be selectively incorporated in control program 1302. Program module 1304 is prepared by a manufacturer or a service provider and is roughly classified into test algorithm module 1304a and analysis tool module 1304b.

### CITATION LIST

### Patent Literature

PTL 1: Japanese Patent No. 5816144

### SUMMARY OF THE INVENTION

In the conventional configuration, since the analysis tool module is prepared by a service provider, a test desired by a user may not be performed. For example, in a case where an object to be measured is changed and the user who performs the test desires to change the analysis and determination algorithm accordingly, if a desired analysis tool module is not provided by the service provider, the user cannot change the algorithm. As a result, the user could not perform desired analysis and determination.

An object of the present disclosure is to provide a determination algorithm setting method that enables a user to freely set an algorithm for analysis and determination without modifying an executable program.

According to one aspect of the present disclosure, there is provided a determination program executed by a processing circuit of a monitoring unit that determines a processed state when processing is performed by irradiating a workpiece with laser light. The determination program includes a control program that is not changeable by a user, and a determination algorithm that is selectively implementable with the control program. The determination algorithm is capable of incorporating one or more parameters defined by a user. The processing circuit executes the determination program to execute receiving data indicating an intensity of the laser light and data indicating an intensity of each component of thermal radiation, visible light, and reflected light generated in a weld portion formed on the workpiece, judging the processed state based on the data received and the determination algorithm incorporating the one or more parameters, and outputting a determination result.

According to the determination program of the present disclosure, it is possible to provide a determination algorithm setting method that enables a user to freely set an algorithm for analysis and determination without modifying an executable program.

### BRIEF DESCRIPTION OF THE DRAWINGS

FIG. 1A is a schematic diagram illustrating an example of a laser processing system according to an exemplary embodiment of the present disclosure.

FIG. 1B is a schematic diagram illustrating an example of a laser processing device of the laser processing system.

FIG. 1C is a schematic diagram illustrating a hardware configuration of a monitoring unit.

FIG. 2 is a diagram illustrating a schematic flowchart of a monitoring unit according to the exemplary embodiment of the present disclosure.

FIG. 3 is a diagram illustrating an example of a measured waveform according to the exemplary embodiment of the present disclosure.

FIG. 4A is a diagram illustrating a relationship between a flowchart of a determination algorithm and an externally-defined parameter in the exemplary embodiment of the present disclosure.

FIG. 4B is a flowchart of a variable definition algorithm according to the exemplary embodiment of the present disclosure.

FIG. 4C is a flowchart of feature extraction operation process according to the exemplary embodiment of the present disclosure.

FIG. 4D is a flowchart of complex feature operation process according to the exemplary embodiment of the present disclosure.

FIG. 4E is a flowchart of determination operation process according to the exemplary embodiment of the present disclosure.

FIG. 5 is a diagram illustrating an example of a label registration screen according to the exemplary embodiment of the present disclosure.

FIG. 6A is a diagram for describing a feature of a measured waveform according to the exemplary embodiment of the present disclosure;

FIG. 6B is a diagram for describing a feature of a measured waveform according to the exemplary embodiment of the present disclosure.

FIG. 6C is a diagram for describing a concept at the time of waveforms measurement according to the exemplary embodiment of the present disclosure.

FIG. 7 is a diagram illustrating an example of a list screen for parameter input of a feature extraction operation according to the exemplary embodiment of the present disclosure.

FIG. 8 is a diagram illustrating an example of a list screen for parameter input of a complex feature operation according to the exemplary embodiment of the present disclosure.

FIG. 9 is a diagram illustrating an example of a list screen for parameter input of determination process operation according to the exemplary embodiment of the present disclosure.

FIG. 10 is a diagram illustrating an example of a display screen of a determination result according to the exemplary embodiment of the present disclosure.

FIG. 11 is a diagram illustrating an example of a measurement screen according to the exemplary embodiment of the present disclosure.

FIG. 12 is a diagram illustrating a conventional determination algorithm setting method described in PTL 1.

### DESCRIPTION OF EMBODIMENT

Hereinafter, exemplary embodiments according to the present disclosure will be described with reference to the drawings. It is noted that a more detailed description than needed may be omitted. For example, detailed description of already well-known matters and redundant description of substantially the same configuration may be omitted. This is to avoid an unnecessarily redundant description and to facilitate understanding of a person skilled in the art. Note that, the attached drawings and the following description are presented by the inventors of the present disclosure so that those skilled in the art can fully understand the present disclosure, and are not intended to limit the subject matter as described in the claims.

Prior to the description of the exemplary embodiments, problems faced by the present inventors will be described more specifically.

As described above, in a case where the user who performs the test desires to change the analysis and determination algorithm, if a desired analysis tool module is not provided by the service provider, the user cannot change the algorithm. Therefore, it is necessary to individually request the service provider to change or modify. However, it takes time to change the algorithm after requesting the service provider. For example, it may be necessary for two weeks or more to create, order, and deliver the software modification specification. Such a situation has been a conventional practice.

In an actual site, in a case where a defect or product switching occurs, it may be necessary to review the manufacturing conditions, and it may be necessary to immediately change the quality determination criteria. If it takes time to change the algorithm, business opportunities are lost.

If the user can change the algorithm by himself/herself, it is considered that the user can cope with the change in about several hours, for example. If such a measure can be taken, the occurrence of the opportunity loss can be suppressed.

Therefore, the present inventors have studied and realized the adoption of the configuration according to the exemplary embodiment described below.

### Exemplary Embodiments

In the present specification, as an exemplary embodiment, a determination system that detects a component of light generated in laser processing for welding and determines a welding shape as a processed state based on a signal corresponding to a temporal change of the detected component will be described.

### 1. Configuration

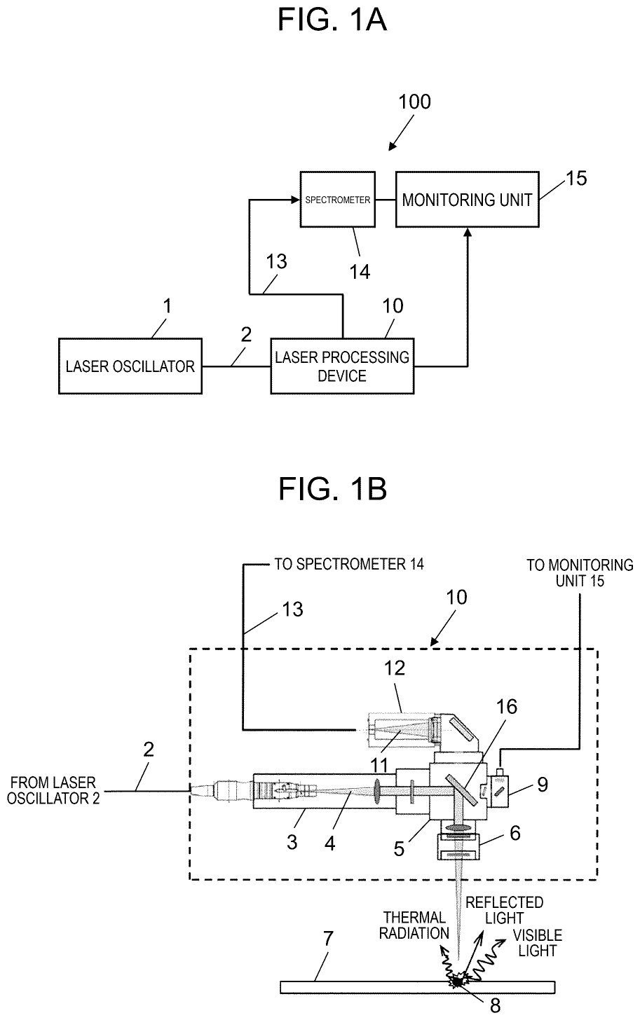

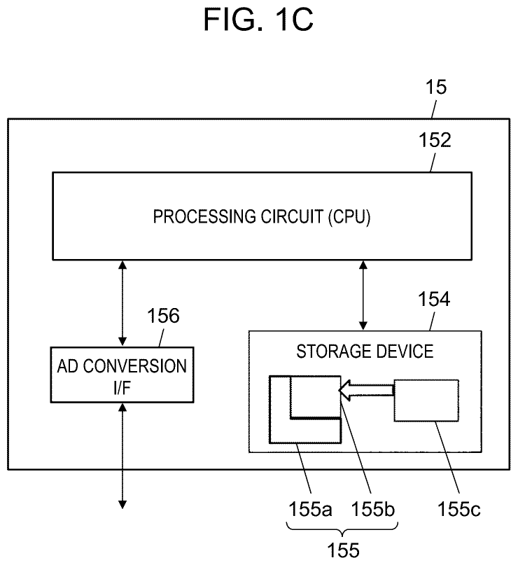

A laser processing system according to the present exemplary embodiment will be described with reference to FIG. 1A.

FIG. 1A shows a schematic configuration of laser processing system 100.

### 1-1. Outline of System

Laser processing system 100 includes laser oscillator 1, laser processing device 10, spectrometer 14, and monitoring unit 15. Laser oscillator 1 and laser processing device 10 are connected by optical fiber 2. Similarly, laser processing device 10 and spectrometer 14 are connected by optical fiber 13. Spectrometer 14 and monitoring unit 15 are connected by a signal line. Similarly, laser processing device 10 and monitoring unit 15 are connected by a signal line.

Laser oscillator 1 and laser processing device 10 perform laser processing for line welding, for example. FIG. 1B illustrates an example of an internal configuration of laser processing device 10. Laser processing device 10 includes emission collimator 3, bending unit 5, condenser lens unit 6, detector unit 9, and condenser collimator 12. A laser beam is input to laser processing device 10 via optical fiber 2. Laser light 4 in laser processing device 10 is converted into a parallel beam by emission collimator 3. A part of the parallel beam is deflected by dielectric multilayer film mirror 16 and enters condenser lens unit 6, and the remaining part enters detector unit 9.

The parallel beam incident on condenser lens unit 6 is radiated to the outside of laser processing device 10. At this time, condenser lens unit 6 converges the parallel beam. The converged light is irradiated onto the workpiece at processing point 8 on work 7 to be processed. For example, work 7 is made of metal, and two members are overlapped and welded. In the present specification, work 7 to be processed may also be referred to as a “workpiece”.

At processing point 8, in a case where work 7 is irradiated with laser light 4, thermal radiation in the near-infrared region due to an increase in temperature, and metal-specific light emission or plasma light emission, which is mainly a visible light component, are generated. In addition, a part of laser light 4 that does not contribute to processing is reflected as return light. As described above, in a case where work 7 is irradiated with laser light 4 from laser processing device 30, thermal radiation, visible light, and reflected light are generated at processing point 8 formed by melting metal on work 7. For convenience of description, in the present specification, a component of thermal radiation may be referred to as “thermal radiation light”.

At processing point 8, the reflected light of laser light 4 and the light emitted by the processing return toward condenser lens unit 6 and bending unit 5. Hereinafter, these are referred to as “return light”. As described above, the return light includes each component of thermal radiation light, plasma light, and reflected light. The return light enters condenser lens unit 6 and further enters bending unit 5. The return light transmitted through dielectric multilayer film mirror 16 is incident on spectrometer 14 by condenser collimator 12 and optical fiber 13.

Spectrometer 14 divides the return light into components of reflected light of the laser, plasma light emitted from the processing point, and thermal radiation light. The respective light is optical-electrical converted by the photodetector and transmitted to monitoring unit 15. In the present exemplary embodiment, since spectrometer 14 that is well-known is used, the detailed description of the configuration of spectrometer 14 is omitted.

On the other hand, detector unit 9 receives the light transmitted through dielectric multilayer film mirror 16 and performs optical-electrical conversion to generate an electric signal indicating the intensity of laser light 4. The rise of the intensity of laser light 4 represented by the electrical signal is used as a trigger when waveform data is recorded. The electrical signal is transmitted to monitoring unit 15.

Monitoring unit 15 receives electrical signals indicative of the intensity of the reflected light, the plasma light and the thermal radiation light that have been optical-electrical converted in spectrometer 14. Monitoring unit 15 simultaneously receives an electrical signal indicating a change in intensity of laser light 4 from detector unit 9. Based on each received electrical signal, monitoring unit 15 performs a predetermined determination and records a determination result. Monitoring unit 15 performs, for example, perforation determination, focus determination when welding, and gap determination.

FIG. 1C is a hardware configuration diagram of monitoring unit 15.

Monitoring unit 15 includes processing circuit 152, storage 154, and AD conversion interface (I/F) 156.

Processing circuit 152 includes a CPU and the like, and the CPU executes a program (software) to implement processing and functions of monitoring unit 15 according to the present exemplary embodiment. Processing circuit 152 may include, instead of the CPU, a processor including a dedicated electronic circuit designed to realize a predetermined function. That is, processing circuit 152 can be realized by various processors such as a CPU, an MPU, a GPU, a DSU, an FPGA, and an ASIC. Processing circuit 152 may include one or more processors.

Storage 154 is a recording medium that functions as a work memory of monitoring unit 15. Storage 154 may include a DRAM and/or a flash ROM. In the present exemplary embodiment, storage 154 stores determination program 155 and parameter setting file 155c to be executed by processing circuit 152.

Determination program 155 includes control program 155a and determination algorithm 155b. Control program 155a is a computer program that is incorporated in software in advance and cannot be changed by the user. Determination algorithm 155b is a program selectively incorporated in control program 155a by the user. Determination algorithm 155b reads parameter setting file 155c that can be freely set by the user. Parameter setting file 155c is a set of externally-defined parameters defined by the user.

AD conversion I/F 156 samples an analog signal at a constant cycle to convert an analog signal into a digital signal. By conversion into a digital signal, processing device 152 can handle the digital signal as an operation target. In the present exemplary embodiment, AD conversion I/F 156 is an interface capable of receiving electrical signals from spectrometer 14 and detector unit 9 of laser processing device 10.

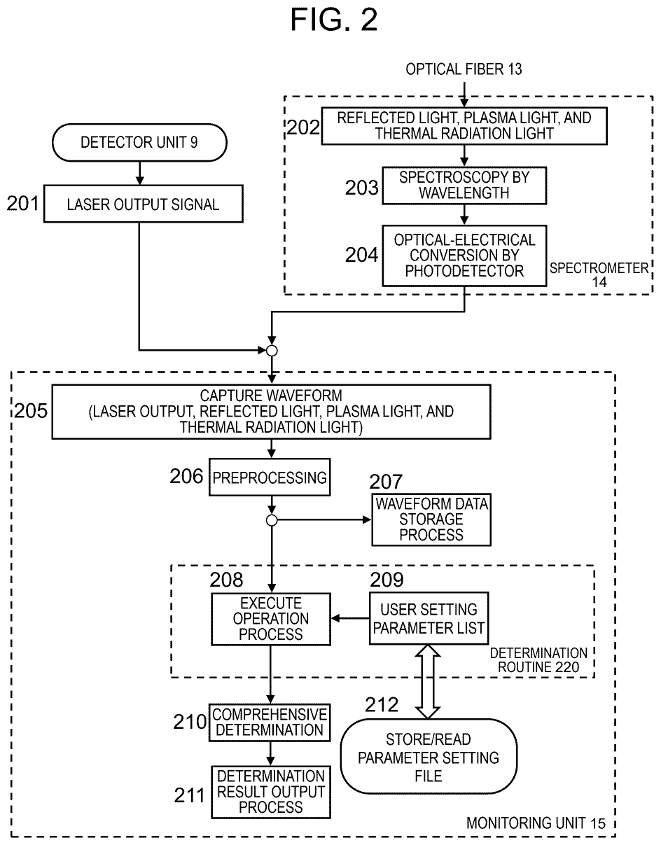

A procedure of the above-described series of operations will be described with reference to FIG. 2.

FIG. 2 is a diagram mainly illustrating a schematic flowchart of monitoring unit 15 in the present exemplary embodiment. The numbers in parentheses in the following description correspond to the reference signs attached to the processing in FIG. 2.

When laser welding is started, return light formed by mixing reflected light, plasma light, and thermal radiation light is transmitted into spectrometer 14 through optical fiber 13 (202). Through spectroscopic (203) by the wavelength, optical-electrical conversion is performed (204) by the photodetector, and the electrical signal is captured in monitoring unit 15.

The subsequent processing of monitoring unit 15 is mainly executed by processing circuit 152. Monitoring unit 15 captures a waveform via AD conversion I/F 156 (205). Processing circuit 152 of monitoring unit 15 performs preprocessing such as a low-pass filter on the waveform data (206), and handover to waveform data storage process (207) and a determination routine (220) is performed. Waveform data of a signal indicating the intensity of laser light 4 and waveform data of a signal indicating an intensity of each of thermal radiation light, visible light, and reflected light generated in a weld portion formed on work 7 are stored by the waveform data storage process (207).

The determination routine (220) corresponds to determination program 155 (FIG. 1C). The operation process (208) realized by the determination routine (220) is processing based on control program 155a and determination algorithm 155b selectively incorporated by the user.

As a premise for the operation of determination algorithm 155b, user setting parameter list 209 is read in advance in determination algorithm 155b. User setting parameter list 209 is a list prepared using parameter setting file 155c, and is a set of one or a plurality of externally-defined parameters selected by the user according to the determination routine (220).

The operation process (208) may include a plurality of operation processes. User setting parameter list 209 may indicate an execution order of a plurality of operation processes by being described in a list format. That is, the operation process (208) may be executed in the described order of user setting parameter list 209.

User setting parameter list 209 can be freely rewritten by the user according to the content of processing desired to be determined by the determination routine (220). By adopting such a software configuration, it is possible to change to the determination process that the user desires to perform using user setting parameter list 209 without changing control program 155a of monitoring unit 15 itself.

Processing circuit 152 executes operation process by determination algorithm 155b based on control program 155a and user setting parameter list 209 (208).

Note that user setting parameter list 209 used for the determination process can be saved in storage 154 or the like as an external file of software of monitoring unit 15. Processing circuit 152 can save or read user setting parameter list 209 (212) via the saving/reading process of the parameter setting file. For example, processing circuit 152 can set the parameters at the time of saving again by reading the saved file. By saving user setting parameter list 209 for each model of the product as an external file, it is possible to easily perform data development to another device or the like at the time of model switching. In addition, when the external file is stored as a file in a binary format or an encrypted file, it is difficult to read the content even when the file is leaked at the time of development to another device, for example, as compared with the case of storing the external file in CSV format including text. This makes it more secure. Note that, in a case where a file is encrypted, a decryption key is available only to a person who has been authenticated.

As a result of execution of the operation process (208), processing circuit 152 acquires one or a plurality of determination results selected by the user, performs comprehensive determination by a combination of the determination results (210), and performs determination result output process (211).

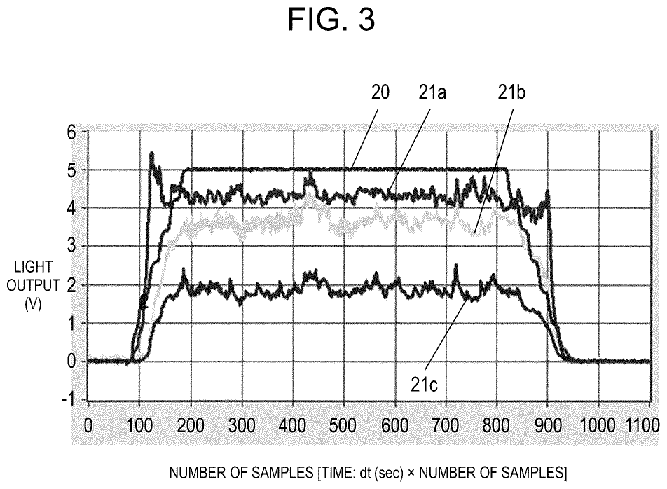

FIG. 3 is a diagram illustrating an example of a measured waveform in the present exemplary embodiment.

In FIG. 3, the horizontal axis represents the number of samples when an analog signal is digitized and captured by AD conversion, and the vertical axis represents a voltage value output by receiving light output by a photodetector. A value obtained by multiplying the number of samples by the sampling interval time set by the parameter indicates the actual elapsed time. In the present exemplary embodiment, the sampling time interval is 5 μs. Scale 1100 on the horizontal axis of the graph of FIG. 3 represents 5.5 milliseconds.

Waveform 20 represents the intensity of an output of laser light 4.

Waveform 21a represents the intensity of the reflected light, waveform 21b represents the intensity of the thermal radiation light, and waveform 21c represents the intensity of the plasma light. As indicated by waveform 20, the output of laser light 4 rises toward scales from 100 to 200 on the horizontal axis. Then, it is observed that the intensity of the reflected light increases until the weld portion starts to melt (waveform 21a), and when the weld portion starts to melt, the intensity of the plasma light (waveform 21c) and the intensity of the thermal radiation light (waveform 21b) rise.

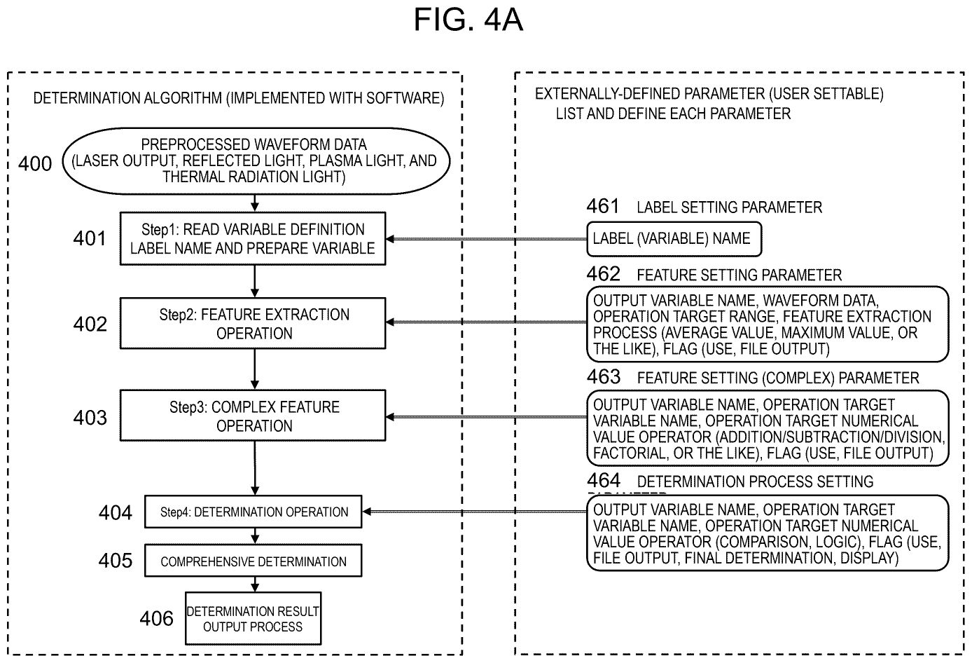

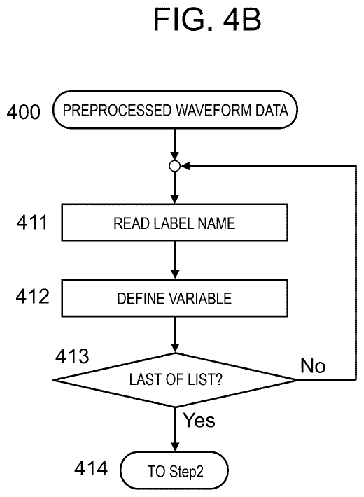

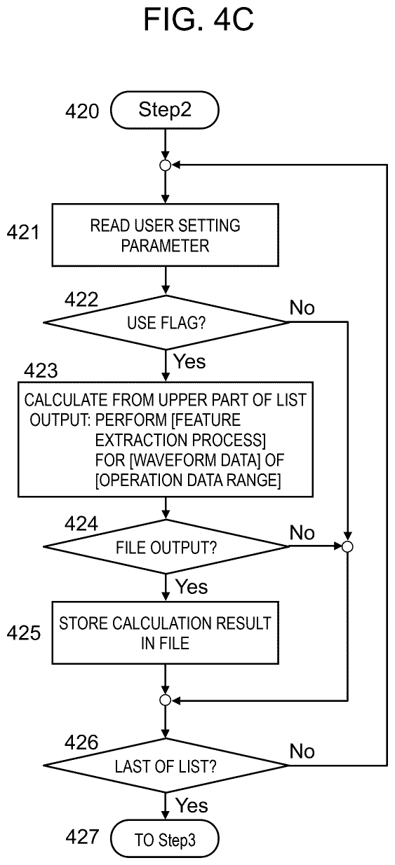

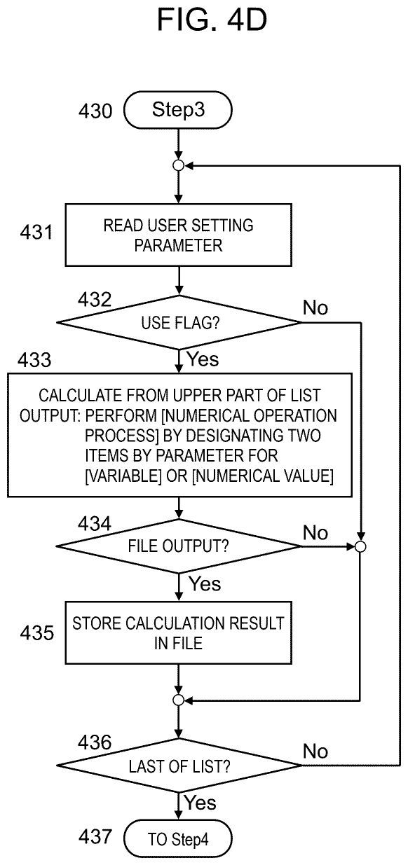

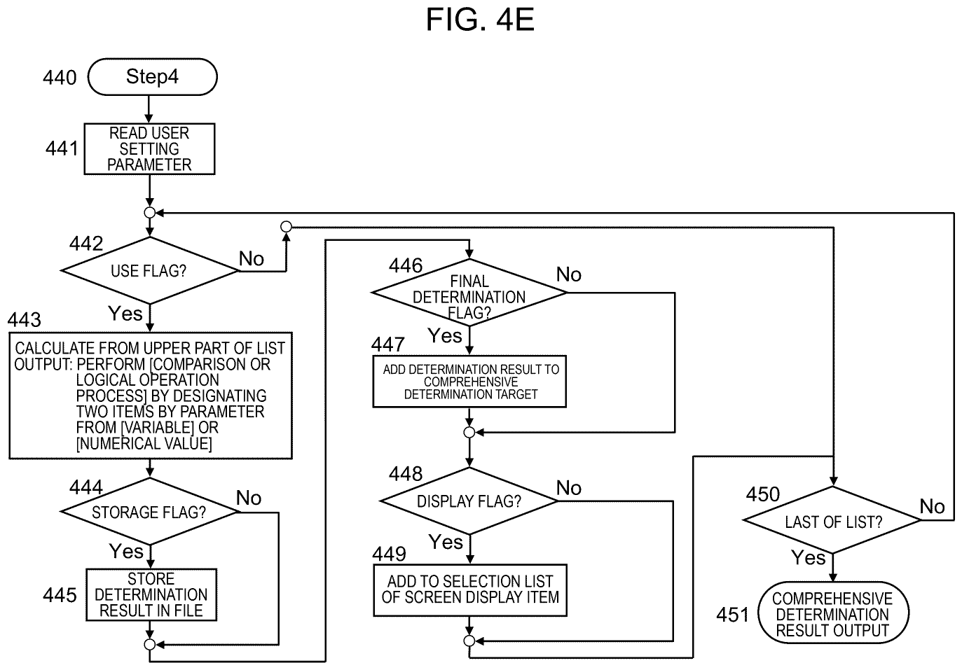

FIGS. 4A to 4E are flowcharts illustrating a procedure of processing of monitoring unit 15 in the present exemplary embodiment.

FIG. 4A illustrates a procedure for introducing an externally-defined parameter into a determination algorithm performed in processing circuit 152.

Processing circuit 152 uses pre-processed waveform data 400 to define variables using user-defined label setting 461 (401). Processing circuit 152 reads feature setting parameter 462 defined by the user based on the above-described defined variable, and performs feature extraction operation (402). Feature setting parameter 462 includes, for example, an output variable name, waveform data, an operation target range, a feature extraction process (average value, maximum value, or the like), and a flag (use, file output).

Next, processing circuit 152 performs a complex feature operation using feature setting (complex) parameter 463 defined by the user (403). Feature setting (complex) parameter 463 includes, for example, an output variable name, an operation target variable name, an operation target numerical value, an operator (addition/subtraction/division, factorial, or the like), and a flag (use, file output).

Subsequently, processing circuit 152 performs determination operation using determination process setting 464 defined by the user (404). Parameters of determination process setting 464 include, for example, an output variable name, an operation target variable name, an operation target numerical value operator (comparison, logic), and a flag (use, output file, final determination, display).

The externally-defined determination algorithm is defined in the form of a list in feature setting 462, feature setting (complex) 463, and determination process setting 464, and enables construction of the algorithm by adopting a method of sequentially performing operation from the top to the bottom of the list. By adopting a structure that the operation order and the operation target can be defined outside the software in this manner, the user can freely set a complicated determination formula without performing software modification.

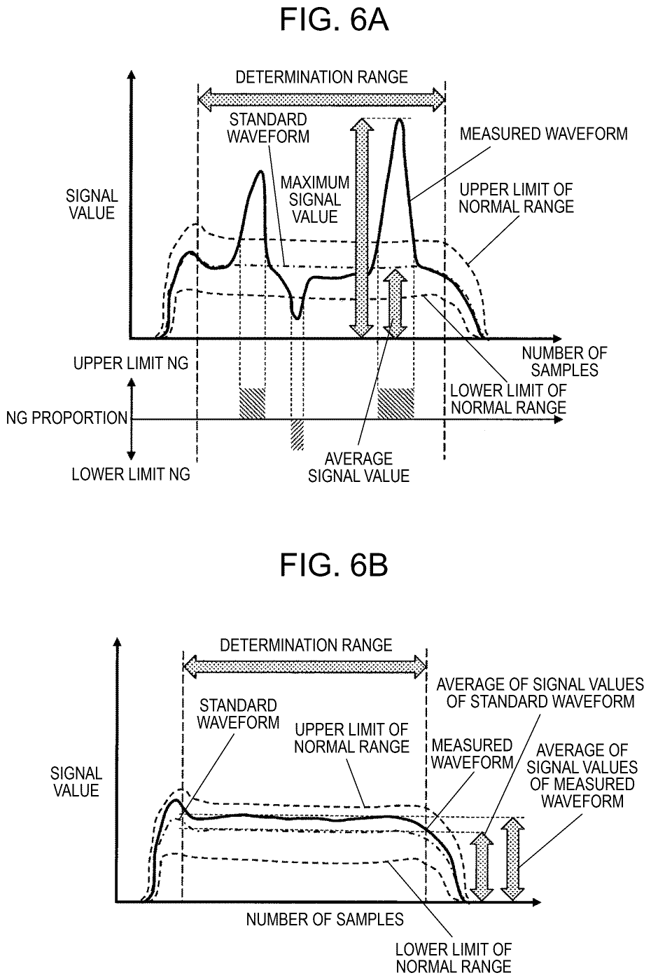

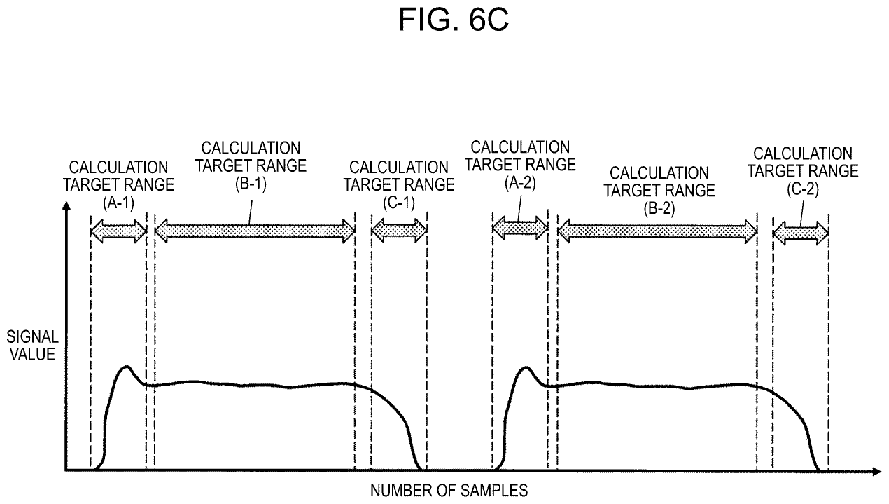

FIGS. 6A and 6B are diagrams for describing a feature of a measured waveform in the present exemplary embodiment. The concept of the feature will be described with reference to FIGS. 6A and 6B.

FIG. 6A is a diagram for describing a concept that waveform data deviates from a normal range. Normally, normal waveform data is observed between the upper limit and the lower limit of the normal range around the standard waveform. In the operation of the feature, a range of the number of samples to be calculated is defined as an operation target range. In the operation target range, an “average signal waveform” is an average of the signal values, and a “maximum signal value” indicates a maximum value of the signal. An “NG proportion” indicates a proportion that the measured light intensity exceeds the upper limit of the normal range or falls below the lower limit of the normal range within the operation target range. The “peak height” indicates a value obtained by dividing the “maximum signal value” by the “average signal value” of the standard waveform and and normalizing the value.

FIG. 6B illustrates a concept of a variation rate. The variation rate represents how much the average of the signal values of the measured waveform has changed with respect to the average of the signal values of the standard waveform in the operation target range by a ratio. When the average of the signal values of the standard waveform is 100% and the average of the signal values of the measured waveform is 120%, the variation rate is 20%. When the average of the signal values of the measured waveform falls below the average of the signal values of the standard waveform, the variation rate is a negative value.

FIG. 6C is a diagram for describing a concept at the time of measuring a plurality of waveforms when laser irradiation is performed a plurality of times in one measurement sampling data. Two solid waveforms indicate changes in signal values measured when laser irradiation is performed. In the case of FIG. 6C, it is shown that there are two points where welding is performed with the same parameters. By setting the operation target range for each feature to be extracted, it is possible to extract the corresponding feature at each of a first weld position and a second weld position. In this case, the operation target ranges at an initial stage of welding are associated with (A-1) and (A-2), the operation target ranges at a stable period of a middle stage of welding are associated with (B-1) and (B-2), and the operation target ranges at a final stage of welding are associated with (C-1) and (C-2). In this case, waveforms at two points are shown, but waveforms at three or more points may be present in one measurement sampling data.

FIG. 4B is a flowchart illustrating a detailed procedure of an algorithm of variable definition. After capturing the preprocessed waveform data 400, processing circuit 152 reads a label name defined in a list form by the user from the top of the list (411), and defines a variable (412). Processing circuit 152 determines whether or not the current processing is the last in the list (413), and if the determination indicates Yes, moves the processing to “Step 2” (414), and if the determination indicates No, reads the “label name” according to the next line in the list (411).

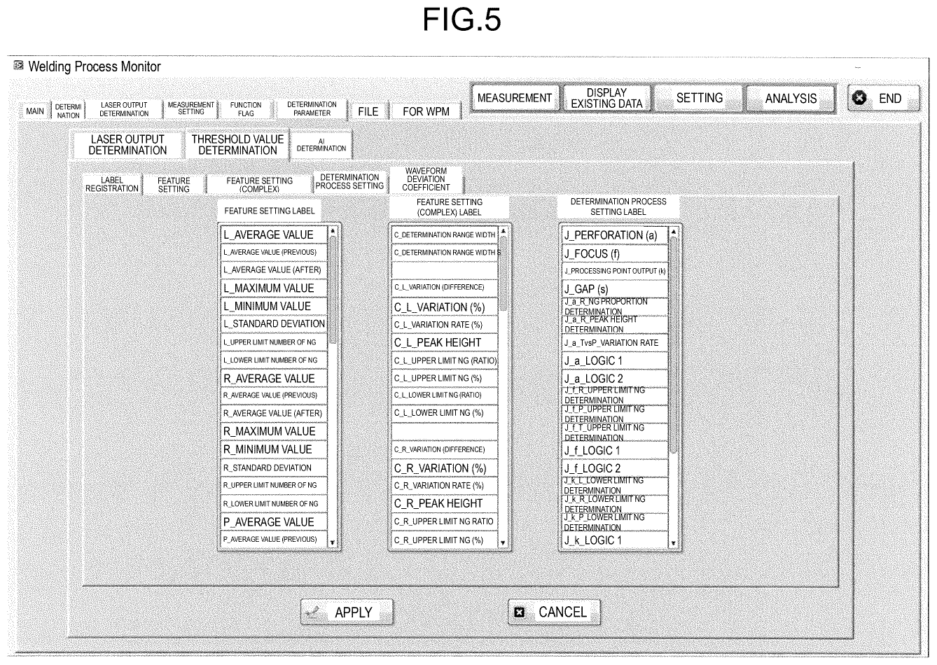

FIG. 5 is a diagram illustrating an example of a label registration screen according to the present exemplary embodiment.

In FIG. 5, label registration can be set for each of three categories. Categories of “feature setting label”, “feature setting (complex) label”, and “determination process setting label” are provided, and detailed items are set in each of the categories.

In the present exemplary embodiment, “L_/R_/P_/T_” is used as a prefix of the “feature setting label”. Each of them represents laser output, reflected light, plasma light, and thermal light, and is used for the user to intuitively understand of the correspondences between light and the feature. A prefix “C_” of the “feature setting (complex) label” represents complex, and is used for easy understanding of the complex feature. The character after “C_” is the same as the prefix of the “feature setting label”. A prefix “J_” of the “determination process setting label” represents determination, and is used for the user to intuitively understand that a label indicates determination process.

Each label can be written in a list form, and is saved as a variable in the memory in order from the top of the list. In each list, insertion and deletion can be performed for each row, and the order of items can be easily changed. In addition, it is also possible to set a blank line, which contributes to improvement of visibility.

By setting each label, it is possible to use the label as a variable name in the feature setting, the feature setting (complex), and the determination process, which are the subsequent processing, and it is possible to prevent setting errors and the like. Note that the specific display illustrated in FIG. 5 is an example. It is also possible to adopt other expressions.

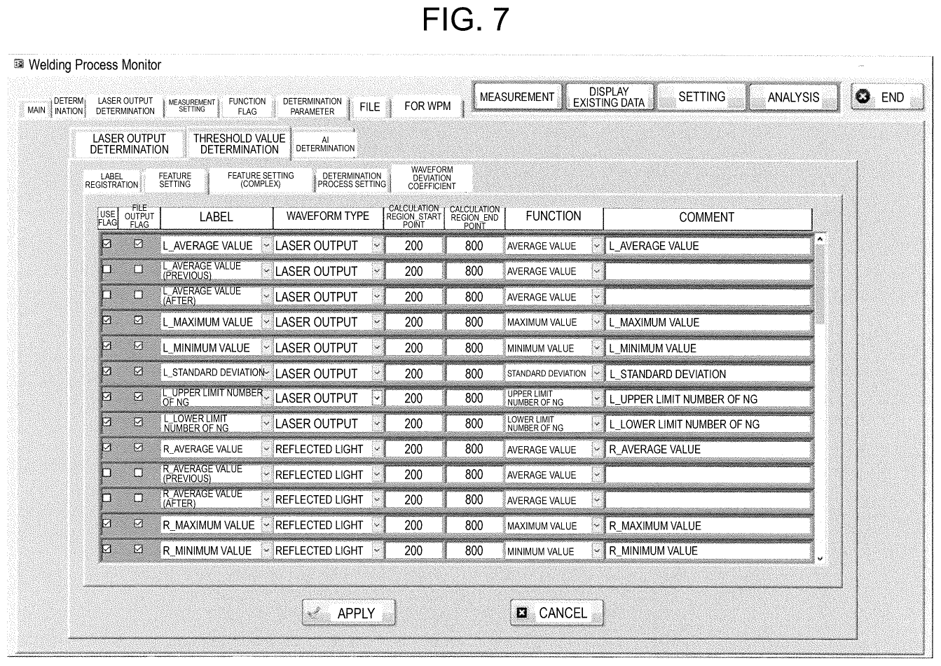

FIG. 4C is a flowchart illustrating details of an algorithm of the feature extraction operation. FIG. 7 is a diagram illustrating an example of a list screen for parameter input of the feature extraction operation according to the present exemplary embodiment. The feature extraction operation will be described below with reference to FIGS. 4C and 7.

In FIG. 4C, Step2 of the variable definition algorithm is started (420). At this point, processing circuit 152 captures each label of the variable definition algorithm. Processing circuit 152 sequentially reads the user setting parameters defined in the list from the top (421). As illustrated in FIG. 7, the user setting parameter includes “use flag”, “file output flag”, “label”, “waveform type”, “operation region_start point”, “operation region_end point”, “function”, and “comment”.

Referring again to FIG. 4C. Processing circuit 152 determines the presence or absence of the use flag (422). In a case where the determination indicates No, processing circuit 152 reads the parameter of the next line of the list without performing the subsequent processing, and in a case where the determination indicates Yes, the processing proceeds to processing of performing an operation from the top of the list (423).

As the operation process, processing circuit 152 sets “label” as a variable for that an arithmetic result is output, and sets a signal type to be target waveform data as “waveform type”. The operation target range setting of the waveform data can be selected from a list by defining “operation region_start point” to “operation region_end point” using the number of sampling points as an index, and defining a predefined process as “function”.

One of the features of the determination process in the present exemplary embodiment is that the operation target range can be set for each operation process. When at least two or more welds are performed on one product, it is possible to set an operation target range corresponding to each weld. Therefore, waveform data of the number of welds required for one product can be collected as one sampling waveform.

By setting the waveform data as one piece of sampling data as described above, the data is organized while maintaining the relationship between the related data, leading to improvement of the accuracy of determination. In addition, since the operation target range can be set, the feature can be extracted with respect to an arbitrary point in one piece of sampling data, and thus, it is possible to grasp physical features necessary for determination such as the initial stage of welding, the stable period of the middle stage of welding, and the operation target range in the final stage of welding. In addition, the number of extracted features can be easily increased by adding the number of lines of the feature setting screen illustrated in FIG. 7.

As the “function” of the standard size process, for example, an average value, a maximum value, a minimum value, an integral value, a P-V value, a standard deviation, a ratio (%) deviating from an allowable range of signal variation, a ratio (%) deviating upward from an allowable range upper limit of signal variation, a ratio (%) deviating downward from an allowable range lower limit of signal variation, and the like can be adopted.

Any text can be input to the “comment” in FIG. 7. The “comment” is used in a case where the screen display of the feature is performed at the time of actual operation in order for the user to easily understand the content.

Referring again to FIG. 4C. Processing circuit 152 determines whether to output a file (424). In a case where the “file output flag” is checked, processing circuit 152 stores the value of the feature that is the operation result in the file (425). In a case where it is not checked, the process proceeds to the next process (426).

Subsequently, processing circuit 152 determines whether the current processing is the last of the list (426). For example, in a case where the last line of the list of the feature setting screen illustrated in FIG. 7 has not yet been executed, processing circuit 152 returns to the user setting parameter reading process (421) for the next line of the list and continues the processing. In a case where the execution of the last line is completed, the process proceeds to “Step 3” (427).

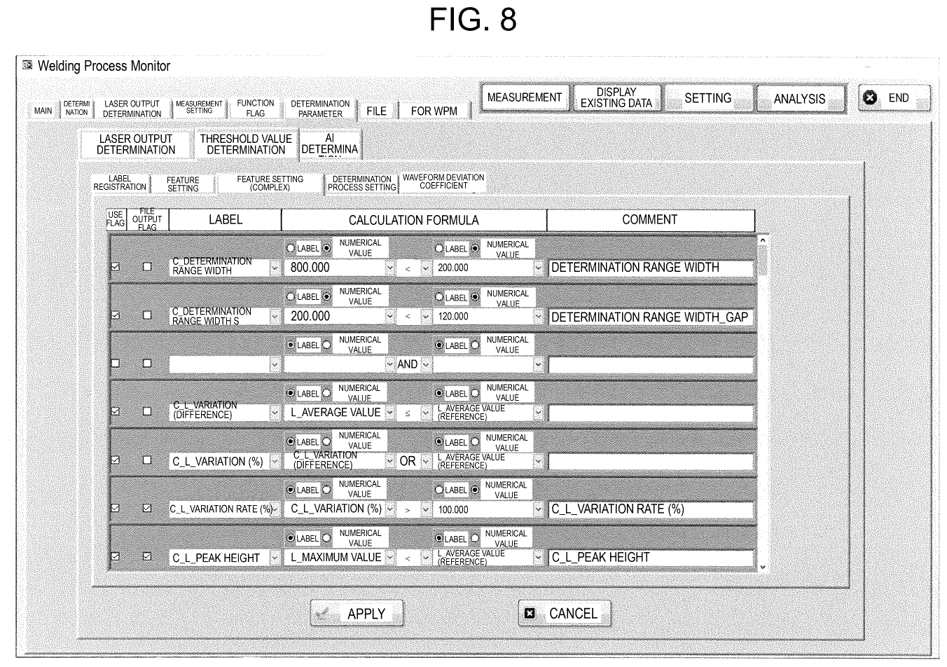

FIG. 4D is a flowchart illustrating details of an algorithm of the complex feature operation. In addition, FIG. 8 is a diagram illustrating an example of a list screen for parameter input of the complex feature operation in the present exemplary embodiment. The complex feature operation will be described below with reference to FIGS. 4D and 8.

In FIG. 4D, Step3 of the complex feature operation algorithm is started (430). At this point, processing circuit 152 captures each feature by a feature extraction operation algorithm.

Processing circuit 152 sequentially reads the user setting parameters defined in the list of the feature settings (complex) illustrated in FIG. 8 from the top (431). As illustrated in FIG. 8, the user setting parameter includes a “use flag”, a “file output flag”, a “label”, an “mathematical formula”, and a “comment”. For example, in the “mathematical formula”, values of two items set from a “label” variable or a “numerical value” and an operator used for these operations can be set by the user.

Referring again to FIG. 4D. Processing circuit 152 determines the presence or absence of the use flag (432). In a case where the determination indicates No, processing circuit 152 does not perform the subsequent processing and proceeds to the determination as to whether or not it is the last of the list (436). In a case where the determination indicates Yes, processing circuit 152 proceeds to processing of performing operation from the upper part of the list (433).

As the operation process, processing circuit 152 uses the “feature setting (complex) label” as a variable for that the operation result is output, and inputs a variable or a numerical value set by the “feature setting label” in the “mathematical formula” to perform operation. The operation may be addition, subtraction, multiplication, division, or the like. An arbitrary sentence can be input to the “comment”, and the comment is used when the feature is displayed on the screen at the time of actual operation in order for the user to easily understand the content.

Referring again to FIG. 4D. Processing circuit 152 determines whether to output a file (434). In a case where the “file output flag” is checked, processing circuit 152 stores the value of the feature that is the operation result in the file (435). In a case where it is not checked, the process proceeds to the next process (436).

Subsequently, processing circuit 152 determines whether the current processing is the last of the list (436). For example, in a case where the last line of the list on the feature setting (complex) screen illustrated in FIG. 8 has not yet been executed, processing circuit 152 returns to the user setting parameter reading process (431) and executes processing on the next line of the list. In a case where the execution of the last line ends, the process proceeds to “Step 4” (437).

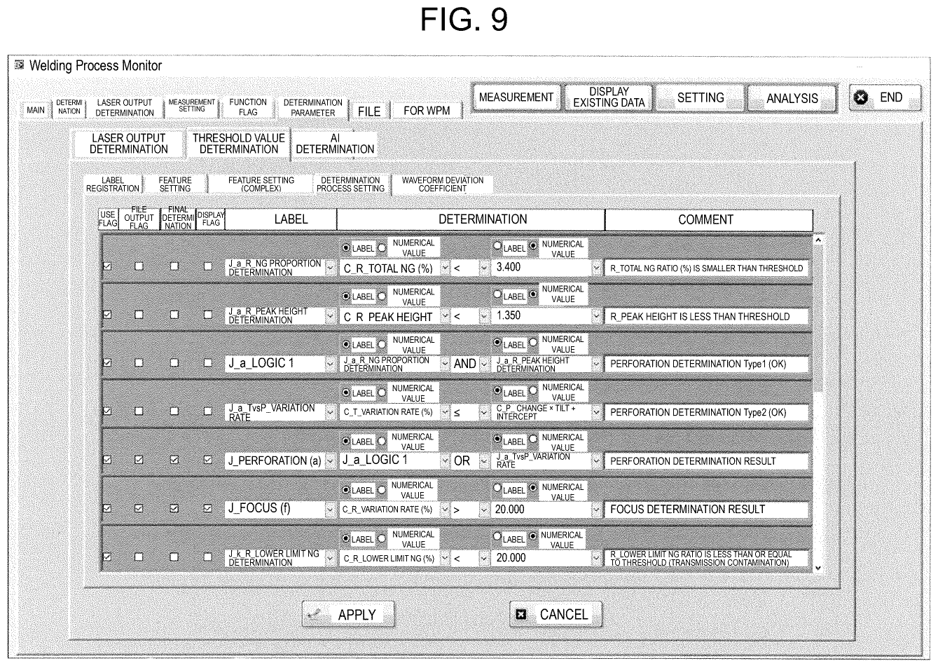

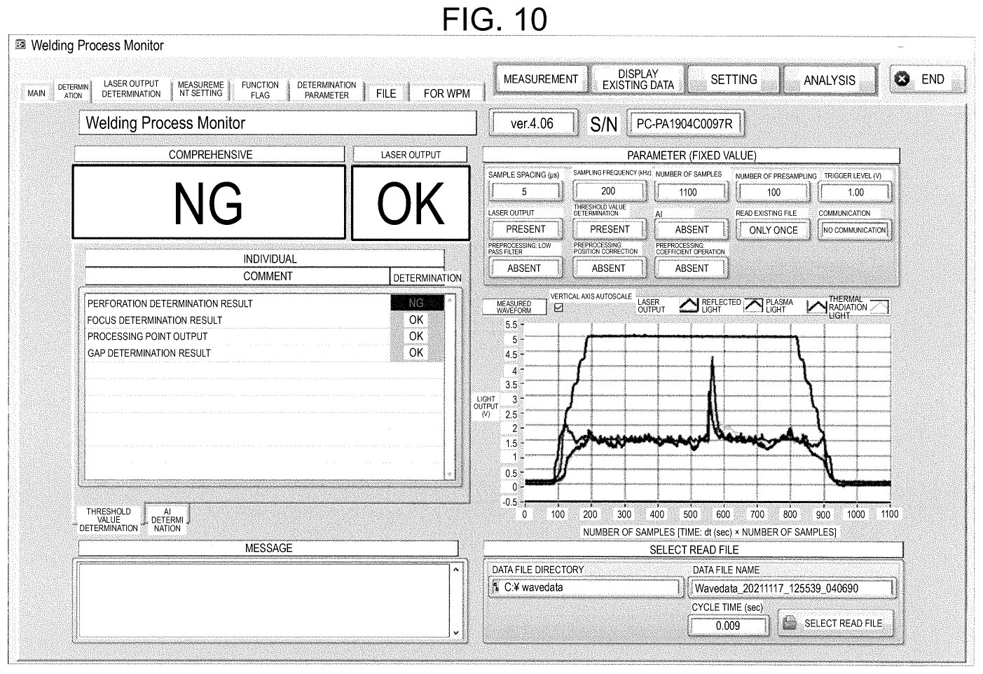

FIG. 4E is a diagram illustrating an algorithm of the determination operation. FIG. 9 is a diagram illustrating an example of a list screen for parameter input of determination process operation in the present exemplary embodiment. FIG. 10 is a diagram illustrating an example of a display screen of a determination result. The determination process operation will be described below with reference to FIGS. 4E, 9, and 10.

In FIG. 4E, Step4 of the complex feature operation algorithm is started (440). At this point, processing circuit 152 captures each feature.

Processing circuit 152 sequentially reads user setting parameters defined in the list of determination process settings illustrated in FIG. 9 from the top (441). As illustrated in FIG. 9, the user setting parameter includes a “use flag”, a “file output flag”, a “final determination flag”, a “display flag”, a “label”, a “determination formula”, and a “comment”. In the “determination formula”, values of two items set from the “label” variable or the “numerical value” and an operator used for a comparison operation or a logical operation thereof can be set by the user.

Referring again to FIG. 4E. Processing circuit 152 determines the presence or absence of the use flag (442). In a case where the determination indicates No, processing circuit 152 does not perform the subsequent processing and proceeds to the determination as to whether or not it is the last of the list (450). In a case where the determination indicates Yes, processing circuit 152 proceeds to a process of performing an operation from the next upper part of the list (443).

As the operation process, processing circuit 152 uses the “determination process setting label” as a variable for that the operation result is output, inputs variables or numerical values set in the “feature setting label”, the “feature setting (complex) label”, and the “determination process setting label” in the “determination formula”, and performs the determination operation. The comparison operator used in the determination operation may be “>, ≥, <, ≤, = ≠, or the like”, and the logical operator may be “AND, OR, NAND, NOR, NOT, XOR, or the like”. An arbitrary sentence can be input to the “comment”, and the comment is used when the feature is displayed on the screen at the time of actual operation in order for the user to easily understand the content.

Referring again to FIG. 4E. Processing circuit 152 determines whether to output a file (444). When the “file output flag” is checked, processing circuit 152 stores the result of the determination process in the file (445). In a case where the check is not performed, file saving process is passed.

Next, processing circuit 152 determines whether the flag is the final determination flag (446). When the “final determination flag” is checked, processing circuit 152 adds the determination result to the target of the comprehensive determination (447), and when the “final determination flag” is not checked, the processing circuit moves to the next processing (448).

Subsequently, processing circuit 152 determines whether or not a display flag is present (448). When the “display flag” is checked, processing circuit 152 adds the determination result to a selection list of the screen display item (449). As a result, the determination result is displayed in the column of “individual determination” as illustrated in FIG. 10. When it is not checked, the process proceeds to the next process (450).

Subsequently, processing circuit 152 determines whether it is the last of the list (450). In a case where the last line of the list on the determination process setting screen illustrated in FIG. 9 has not yet been executed, processing circuit 152 returns to the user setting parameter reading process (450) for the next line of the list and continues the processing. When the execution of the last row is completed, processing circuit 152 proceeds to the comprehensive determination result output process (451). In the comprehensive determination, the comprehensive determination is OK when all the items extracted by “addition of determination result to target of comprehensive determination” 447 and all the items of the laser output determination indicate OK.

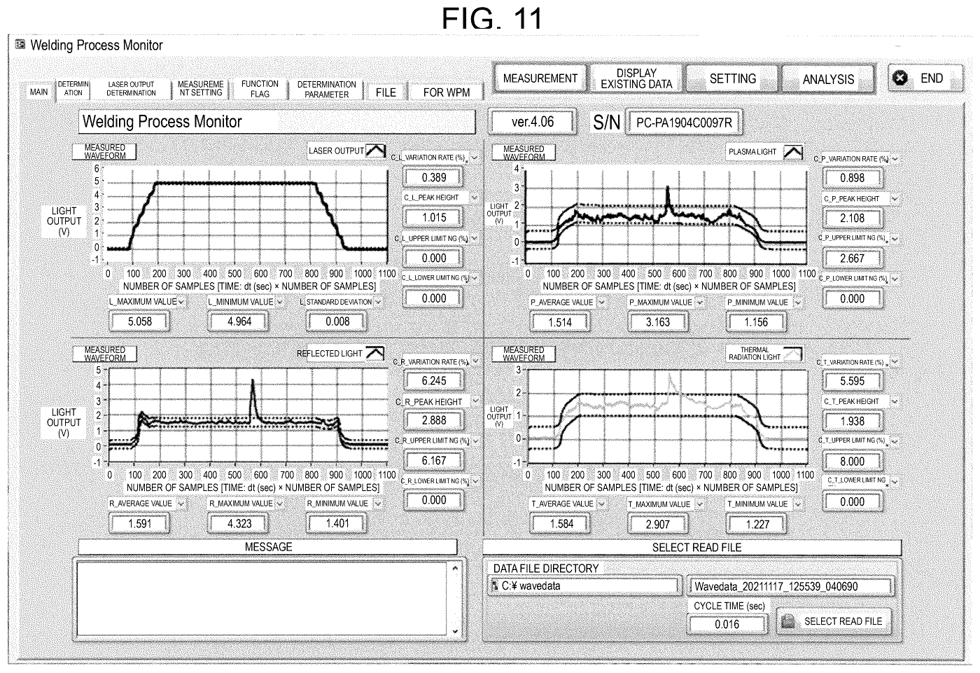

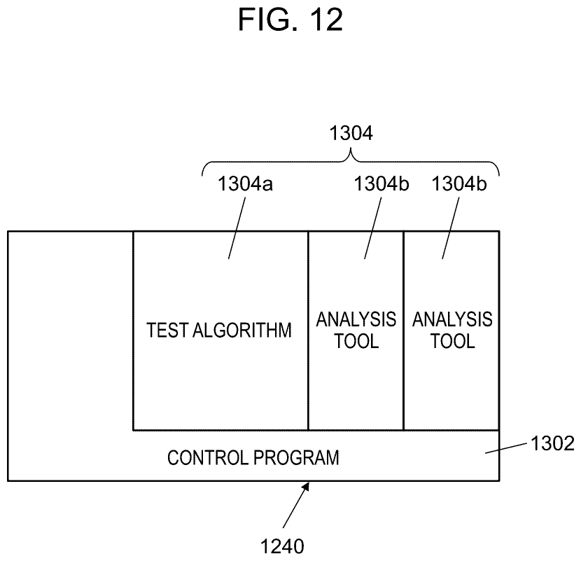

FIG. 11 is a diagram illustrating an example of a measurement screen in the present exemplary embodiment.

In FIG. 11, the relationship between the number of samples of the laser output, the reflected light, the plasma light, and the thermal radiation light and the voltage value corresponding to the intensity of the light output is graphically illustrated. Display areas for features are provided on the lower side and the right side of each graph. By selecting this feature from the pull-down list, the user can select and display an arbitrary feature. In the pull-down list, all the features of the label registration screen illustrated in FIG. 5 are displayed in a complicated manner. Therefore, only the features whose file output flags are checked on the feature setting screen illustrated in FIG. 7, the feature (complex) setting screen illustrated in FIG. 8, and the determination process setting screen illustrated in FIG. 9 are displayed.

The feature setting screen illustrated in FIG. 7, the feature (complex) setting screen illustrated in FIG. 8, and the determination process setting screen illustrated in FIG. 9 have a feature that operation process is performed from the upper side to the lower side of the list, and description can be performed in order according to an algorithm desired to be set by the user. Further, each list holds editing functions such as insertion, deletion, change of arrangement order, copy, and paste for each row.

According to the above configuration, by listing the processing procedure of the operation process of the determination algorithm and giving the list as the user parameter to the program, the determination algorithm can be changed without modifying the code of the program, the change of the analysis and determination method due to the product change or the like can be quickly taken in the production site, and the opportunity loss can be minimized.

In a case where welding is actually performed in mass production of electronic components, when a defect occurs in a product, it is necessary to promptly review manufacturing conditions in order to minimize downtime in a manufacturing process. Accordingly, it is necessary to change the quality determination criterion and the determination algorithm. In such a case, when a manufacturer is requested to perform software modification, it usually takes several weeks from preparation of a modification specification to order placement to delivery. However, according to the exemplary embodiment of the present disclosure, since the quality determination criterion and the algorithm can be changed by the user at the production site, it is possible to suppress the occurrence of the opportunity loss without waiting for the response of the service provider.

The above description is merely an example. For example, for at least one of the extraction of the feature, the numerical operation of the feature, and the logical operation, the “mathematical formula” may be constructed using values of two items set from the “label” variable or the “numerical value” and an operator used for these operations.

### ASPECTS OF PRESENT DISCLOSURE

As described above, the present disclosure includes the following aspects.

### (Aspect 1)

A determination program executed by a processing circuit of a monitoring unit that determines a processed state when processing is performed by irradiating a workpiece with laser light,
the determination program comprising:
   a control program that is not changeable by a user; and
   a determination algorithm that is selectively implementable with the control program,
wherein
the determination algorithm is capable of incorporating one or more parameters defined by a user,
the processing circuit executes the determination program to execute:
receiving data indicating an intensity of the laser light and data indicating an intensity of each component of thermal radiation, visible light, and reflected light generated in a weld portion formed on the workpiece;
judging the processed state based on the data received and the determination algorithm incorporating the one or more parameters; and
outputting a determination result.

### (Aspect 2)

The determination program according to Aspect 1,
wherein the determination algorithm includes a plurality of types of operation processes,
the one or more parameters are a plurality of parameters, incorporated into the determination algorithm before execution of the determination program, as data necessary for each of the plurality of types of operation processes, and indicate an order of executing the plurality of types of operation processes, and
the processing circuit executes the determination program to execute the plurality of types of operation processes according to an order indicated by the plurality of parameters.

### (Aspect 3)

The determination program according to Aspect 2, wherein
the plurality of parameters are created in a list format, and an order of a list indicates an order of executing the plurality of types of operation processes, and
the list is created in advance by the user and incorporated into the determination algorithm before execution of the determination program.

### (Aspect 4)

The determination program according to Aspect 3,
wherein
the plurality of parameters include a label indicating each of the plurality of types of operation processes,
each label is capable of having a plurality of parameters according to operation process, and
the plurality of types of operation processes includes extraction of a predetermined feature included in an intensity of at least one of the thermal radiation, the visible light, and the reflected light based on the data indicating an intensity of the laser light and data indicating an intensity of each component of the thermal radiation, the visible light, and the reflected light that have been received, numerical operation of the predetermined feature, and logical operation for determination based on a result of the numerical operation that has been extracted.

### (Aspect 5)

The determination program according to Aspect 2, wherein the plurality of parameters are stored in a file, and the file is read before execution of the determination program to be incorporated into the determination algorithm.

### (Aspect 6)

The determination program according to Aspect 5, wherein the file is a binary file or an encrypted file.

### (Aspect 7)

The determination program according to Aspect 4,
wherein
the plurality of parameters include at least one mathematical formula, and
the processing circuit executes the determination program to execute the numerical operation and/or the logical operation according to the at least one mathematical formula.

### (Aspect 8)

The determination program according to Aspect 4,
wherein
data indicating an intensity of the laser light and data indicating an intensity of each component of the thermal radiation, the visible light, and the reflected light are waveform data indicating a waveform of each intensity, and
the plurality of parameters include designation of a range used for operation for each waveform data.

### INDUSTRIAL APPLICABILITY

A determination algorithm setting method according to the present disclosure has a function of quickly responding to a change in an analysis and determination method due to a product change or the like at a production site, and can also be applied to quality assurance applications in production of electronic components such as batteries.

### REFERENCE MARKS IN THE DRAWINGS

1 laser oscillator
2 optical fiber
3 emission collimator
4 laser light
5 bending unit
6 condenser lens unit
7 work
8 processing point
9 detector unit
10 signal line
11 reflected light, plasma light, and thermal radiation light
12 condenser collimator
13 optical fiber
14 spectrometer
15 optical signal collection unit
16 dielectric multilayer film mirror

1. A determination program executed by a processing circuit of a monitoring unit that determines a processed state when processing is performed by irradiating a workpiece with laser light,
the determination program comprising:
a control program that is not changeable by a user; and
a determination algorithm that is selectively implementable with the control program,
wherein
the determination algorithm is capable of incorporating one or more parameters defined by a user,
the processing circuit executes the determination program to execute:
receiving data indicating an intensity of the laser light and data indicating an intensity of each component of thermal radiation, visible light, and reflected light generated in a weld portion formed on the workpiece;
judging the processed state based on the data received and the determination algorithm incorporating the one or more parameters; and
outputting a determination result.

2. The determination program according to claim 1,
wherein
the determination algorithm includes a plurality of types of operation processes,
the one or more parameters are a plurality of parameters, incorporated into the determination algorithm before execution of the determination program, as data necessary for each of the plurality of types of operation processes, and indicate an order of executing the plurality of types of operation processes, and
the processing circuit executes the determination program to execute the plurality of types of operation processes according to an order indicated by the plurality of parameters.

3. The determination program according to claim 2,
wherein
the plurality of parameters are created in a list format, and an order of a list indicates an order of executing the plurality of types of operation processes, and
the list is created in advance by the user and incorporated into the determination algorithm before execution of the determination program.

4. The determination program according to claim 3,
wherein
the plurality of parameters include a label indicating each of the plurality of types of operation processes,
each label is capable of having a plurality of parameters according to operation process, and
the plurality of types of operation processes includes extraction of a predetermined feature included in an intensity of at least one of the thermal radiation, the visible light, and the reflected light based on the data indicating an intensity of the laser light and data indicating an intensity of each component of the thermal radiation, the visible light, and the reflected light that have been received, numerical operation of the predetermined feature, and logical operation for determination based on a result of the numerical operation that has been extracted.

5. The determination program according to claim 2, wherein the plurality of parameters are stored in a file, and the file is read before execution of the determination program to be incorporated into the determination algorithm.

6. The determination program according to claim 5, wherein the file is a binary file or an encrypted file.

7. The determination program according to claim 4,
wherein
the plurality of parameters include at least one mathematical formula, and
the processing circuit executes the determination program to execute the numerical operation and/or the logical operation according to the at least one mathematical formula.

8. The determination program according to claim 4,
wherein
data indicating an intensity of the laser light and data indicating an intensity of each component of the thermal radiation, the visible light, and the reflected light are waveform data indicating a waveform of each intensity, and
the plurality of parameters include designation of a range used for operation for each waveform data.
